(19) United States
(12) Patent Application Publication
(10) Pub. No.: US 2019/0018440 A1
(43) Pub. Date: Jan. 17, 2019

(54) ROTATIONAL OPERATION DEVICE

(71) Applicant: KABUSHIKI KAISHA TOKAI RIKA DENKI SEISAKUSHO, Aichi (JP)

(72) Inventors: Shinya ISHIMARU, Aichi (JP); Hiroshi ITOKAWA, Aichi (JP)

(21) Appl. No.: 16/069,324

(22) PCT Filed: Feb. 1, 2017
(86) PCT No.: PCT/JP2017/003550

§ 371 Date: Jul. 11, 2018

(30) Foreign Application Priority Data
Feb. 5, 2016 (JP) 2016-020502

(51) Int. Cl. G05G 1/10; F21V 11/08; G05G 1/08; G05G 25/00

(52) U.S. Cl. CPC G05G 1/105; G05G 25/00; G05G 1/08; F21V 11/08

(57) ABSTRACT

A rotational operation device includes a light source configured to output illumination light, a display portion including plural display targets formed in a circumferential direction, a transmission region that transmits the illumination light, and a light-blocking region that blocks the illumination light, and an operation part configured to rotate together with the display portion in accordance with a performed rotation operation. The operation part is opaque and allows visual recognition of the plurality of display targets by the illumination light output from the light source and transmitted through the transmission region of the display portion.

### TECHNICAL FIELD

The present invention relates to a rotational operation device.

### BACKGROUND ART

A dial operation device including first and second dial members that have a ring shape and rotate around the same axis, as well as a liquid crystal display disposed within the ring is known (for example, Patent Document 1).

In the dial operation device disclosed in Patent Document 1, the operational contents of the first dial member and the second dial member are displayed on the liquid crystal display.

### CITATION LIST

### Patent Literature

PTL1: JP 2006-318962 A

### SUMMARY OF INVENTION

### Technical Problem

The dial operation device disclosed in Patent Document 1 has a problem in that utilizing a liquid crystal display increases the number of parts, which results in an increased cost.

It is an object of the invention to provide a rotational operation device capable of performing display similar to that of a digital display at a low cost using an analog mechanism.

### Solution to Problem

A rotational operation device according to one embodiment of the invention includes: a light source configured to output illumination light; a display portion including a plurality of display targets formed in a circumferential direction, a transmission region that transmits the illumination light, and a light-blocking region that blocks the illumination light; and an operation part configured to rotate together with the display portion in accordance with a performed rotation operation, wherein the operation part is opaque and allows visual recognition of the plurality of display targets by the illumination light output from the light source and transmitted through the transmission region of the display portion.

### Advantageous Effects of Invention

According to an embodiment of the invention, a rotational operation device capable of performing display similar to that of a digital display at a low cost using an analog mechanism can be provided.

### BRIEF DESCRIPTION OF DRAWINGS

FIG. 1 is an exploded perspective view illustrating an example of a rotational operation device according to an embodiment.

FIG. 2 is a block diagram illustrating a configuration of a rotational operation device according to an embodiment.

FIG. 3A is an explanatory diagram illustrating a state of the rotational operation device before illumination, according to an embodiment.

FIG. 3B is an explanatory diagram illustrating a state of the rotational operation device after illumination.

### DESCRIPTION OF EMBODIMENT

### Overview of Embodiment

The rotational operation device according to an embodiment includes: a light source configured to output illumination light; a display portion including a plurality of display targets formed in a circumferential direction, a transmission region that transmits the illumination light, and a light-blocking region that blocks the illumination light; and an operation part configured to rotate together with the display portion in accordance with a performed rotation operation, wherein the operation part is opaque and allows visual recognition of the plurality of display targets by the illumination light output from the light source and transmitted through the transmission region of the display portion.

Since the rotational operation device includes an analog mechanism which is opaque when an operation part is not illuminated and in which a display target becomes visually recognizable when illuminated, display similar to that of a digital display can be performed using an analog mechanism at a low cost in comparison to cases where such a mechanism is not utilized.

### Embodiment

### Overview of Rotational Operation Device 1

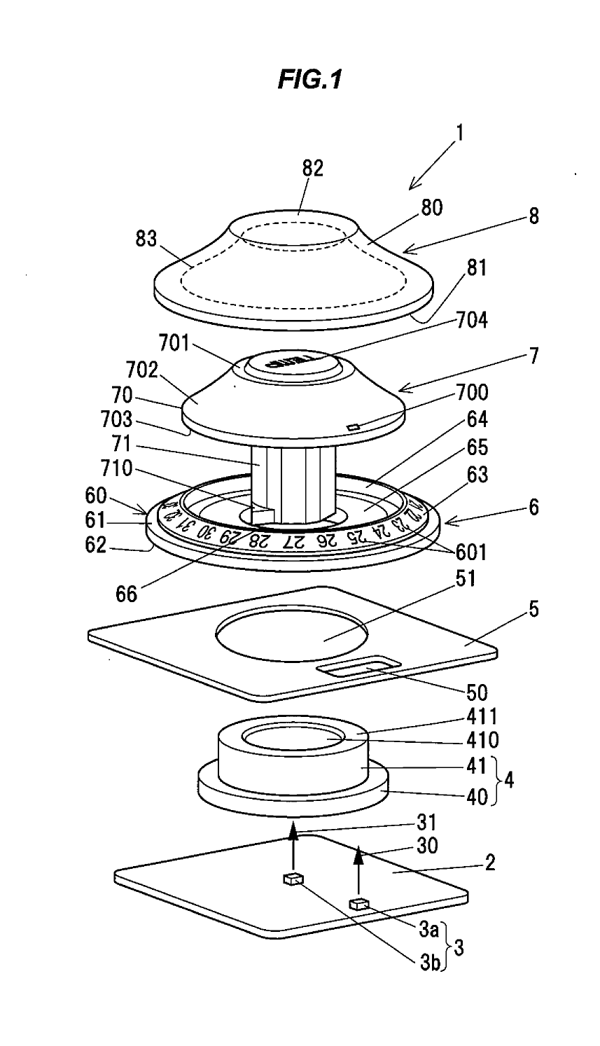

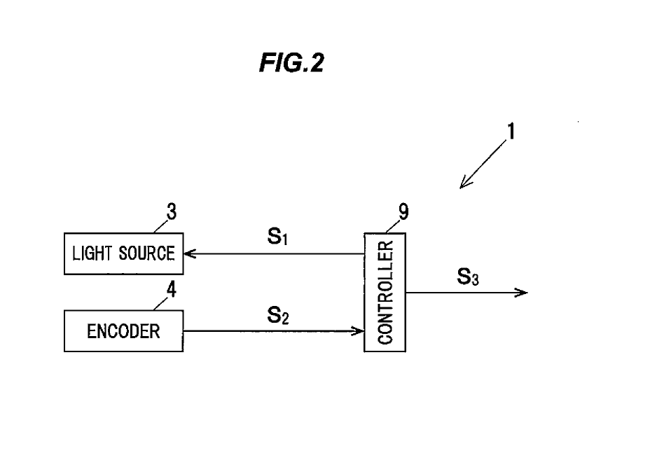

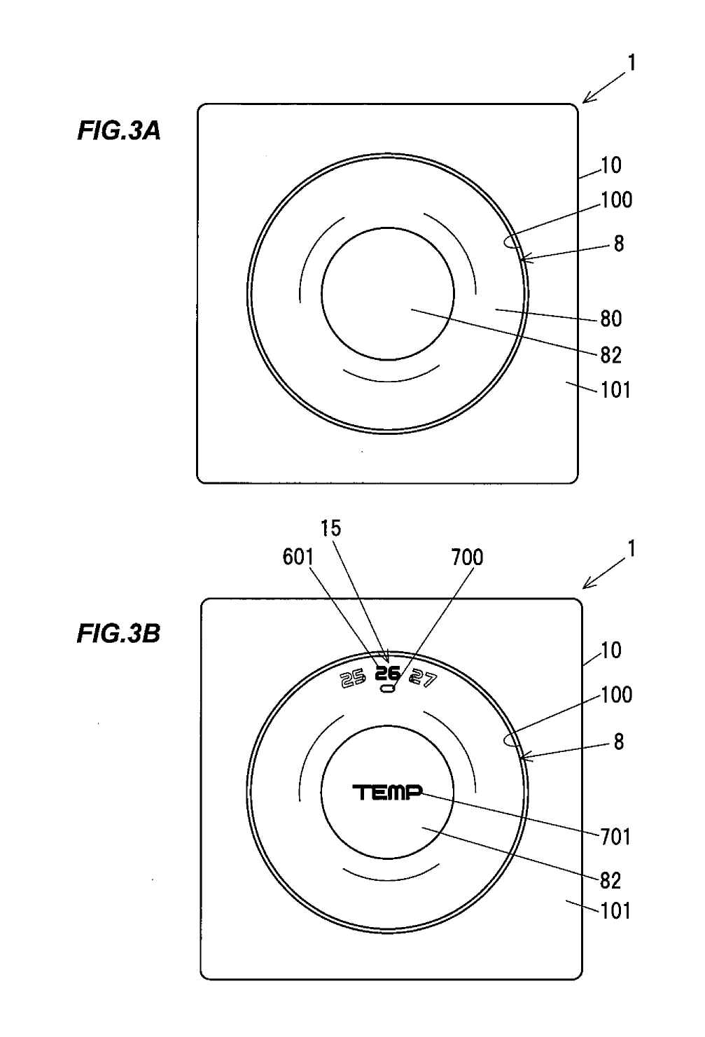

FIG. 1 is an exploded perspective view illustrating an example of a rotational operation device according to an embodiment. FIG. 2 is a block diagram illustrating a configuration of a rotational operation device according to an embodiment. FIG. 3A is an explanatory diagram illustrating a state of the rotational operation device before illumination according to an embodiment, and FIG. 3B is an explanatory diagram illustrating a state of the rotational operation device after illumination. In the drawings associated with the following embodiment, ratios between elements in the drawings may be different from the actual ratios. In addition, in FIG. 2, the arrows indicate the flow of primary signals and information.

As an example, the rotational operation device 1 is a dial-type operation device for setting the temperature, air volume, or the like of an air conditioning device installed in a vehicle. In the present embodiment, the rotational operation device 1 will be described as a device for setting the temperature of an air conditioning device. Note that the rotational operation device 1 is not limited to an air conditioning device, and may also be used for sound volume adjustment of a music player or the like.

As illustrated in FIG. 1, the rotational operation device 1 includes a light source 3 configured to output illumination light 30; a display portion 6 including a plurality of display targets formed in a circumferential direction, a transmission region that transmits the illumination light 30, and a light-blocking region that blocks the illumination light 30; and an operation part 8 configured to rotate together with the display portion 6 in accordance with a performed rotation operation, wherein the operation part 8 is opaque and allows visual recognition of the plurality of display targets by the illumination light 30 transmitted through the transmission region of the display portion 6 by the illumination of the light source 3.

As illustrated in FIG. 1, the display target of the display portion 6 is a temperature display 601, for example. The temperature display 601 is a number from 18 to 30, for example. This number indicates the set temperature of an air conditioning device. In addition, another display target of the support part 7 is a function display 704, as will be described later. Further, a pointer 700 is formed on the support part 7 as a display target.

In addition, as illustrated in FIG. 1 and FIG. 2, the rotational operation device 1 includes an encoder 4 that serves as a rotation detector configured to detect the rotation of the operation part 8 by detecting the rotation of the display portion 6, a light-blocking part 5 disposed between the display portion 6 and the light source 3 and blocking the illumination light 30, a support part 7 disposed between the display portion 6 and the operation part 8, supporting a rotation of the operation part 8 together with the display portion 6 and partially blocking the illumination light 30 and the illumination light 31, and a controller 9.

### Configuration of Light Source 3

The light source 3 is disposed on a substrate 2, which is a printed wiring board, for example. As illustrated in FIG. 1, the light source 3 includes a light-emitting element 3a and a light-emitting element 3b, for example. The light-emitting element 3a and the light-emitting element 3b are Light Emitting Diodes (LEDs), for example. As an example, the light-emitting element 3a and the light-emitting element 3b emit white illumination light 30 and illumination light 31, respectively.

As illustrated in FIG. 1, for example, the light-emitting element 3a is disposed below the transmission opening 50 of the light-blocking part 5. Accordingly, the display portion 6 is illuminated by the illumination light 30 through the transmission opening 50 of the light-blocking part 5, and the temperature display 601 is made to be displayed on the operation part 8. In addition, a conical portion 70 of the support part 7 is illuminated by the illumination light 30 through the transmission opening 50 of the light-blocking part 5 and the display portion 6, and the pointer 700 is made to be displayed on the operation part 8.

As illustrated in FIG. 1, the light-emitting element 3b is disposed below a cylindrical portion 71 of the support part 7, for example. Accordingly, an upper surface 701 of the support part 7 is illuminated by the illumination light 31 through the cylindrical portion 71 of the support part 7 inserted into a through-hole 410 of the encoder 4, and the function display 704 is made to be displayed on the operation part 8.

For example, as illustrated in FIG. 2, the light source 3 is configured to emit light on the basis of the drive signal S₁ output from the controller 9.

### Configuration of Encoder 4

The encoder 4 is configured to detect the rotation amount of the operation part 8 in the forward and reverse directions. The encoder 4 outputs the detected result to the controller 9 as rotation amount information S₂. The encoder 4 includes, for example, a detector 40 and a rotation portion 41.

As an example, the encoder 4 is an optical encoder of an increment type or an absolute type. The reference position of the encoder 4 is determined, for example, by a protrusion 710 of the support part 7, which will be described later. This protrusion 710 is inserted into a recess of the detector 40 of the encoder 4, for example, and thus the support part 7 is attached to the detector 40, and the position of the detector 40 and the support part 7 are determined.

The detector 40 is attached to the substrate 2, for example. The rotation portion 41 is configured to rotate with respect to the detector 40, for example. The rotation portion 41 has a cylindrical shape, and a through-hole 410 is formed therein. The cylindrical portion 71 of the support part 7 is inserted into the through-hole 410. Since the upper surface 411 of the rotation portion 41 is attached to the back surface 62 of the display portion 6, the rotation portion 41 rotates together with the display portion 6 and the operation part 8.

Note that, as a modification, the rotation detector is not limited to the encoder 4, and may detect the rotation of the display portion 6 using a laser or the like.

### Configuration of Light-Blocking Part 5

As an example, the light-blocking part 5 has a plate shape as illustrated in FIG. 1. The light-blocking part 5 is formed using a material which does not transmit the illumination light 30.

The light-blocking part 5 includes a transmission opening 50 through which the illumination light 30 is transmitted, and the temperature display 601 and the pointer 700 are illuminated by the illumination light 30 transmitted through the transmission opening 50. The transmission opening 50 is formed below the temperature display 601 of the display portion 6.

In addition, the transmission opening 50 has a shape that corresponds to the display target of the illumination target and the display targets on both sides of the display target. In particular, for example, when the display target of the illumination target is “24” in the temperature display 601, the transmission opening 50 has a shape such that the “23” and “25” on both sides thereof are illuminated. Then, as illustrated in FIG. 3B, the display targets on both sides are partially illuminated and displayed as a gradation display 15.

The light-blocking part 5 further includes an insertion opening 51. In the insertion opening 51, the cylindrical portion 71 of the support part 7 and the rotation portion 41 of the encoder 4 are inserted. Note that, as a modification, a configuration may be used in which the display portion 6 includes a protruding portion protruding from the back surface 62, and this protruding portion is inserted into the insertion opening 51 and attached to the rotation portion 41 of the encoder 4.

### Configuration of Display Portion 6

The display portion 6 is formed in a disc shape using a synthetic resin material such as acrylic or polycarbonate, for example. As described above, the display portion 6 includes a transmission region that transmits the illumination light 30, and a light-blocking region that blocks the illumination light 30. The light-blocking region is the main body 60. In addition, the transmission region is the temperature display 601 and a bottom surface 65.

Here, conceivable configurations for causing the operation part 8 to display the temperature display 601 include a configuration in which the temperature display 601 is an opening, a configuration in which the temperature display 601 does not transmit the illumination light 30 but the periphery thereof transmits the illumination light 30, and a configuration in which the outer shape of the temperature display 601 which is formed by the periphery and the inner portion of the temperature display 601 blocks the illumination light 30, and the periphery and the inner portion transmit the illumination light 30.

The temperature display 601 of the present embodiment is an opening, and is formed by using a laser or the like. With the exception of the bottom surface 65, the display portion 6 is painted black in order to block light. Note that, as a modification, the display portion 6 may be formed by two-color formation together with the main body 60 using a synthetic resin member that transmits the illumination light 30 for the temperature display 601, or may be formed by bonding a film printed with the temperature display 601.

The main body 60 of the display portion 6 includes an inclined surface portion 63 on the front surface 61. The temperature display 601 is formed on the inclined surface portion 63. In addition, a housing portion 64 is formed at the center of the inclined surface portion 63.

The housing portion 64 has a concave shape cut out into a circle, and the conical portion 70 of the support part 7 that will be described later may be inserted therein. In addition, a circular insertion opening 66 is formed in the center of the bottom surface 65 of the housing portion 64.

### Configuration of Support Part 7

The support part 7 is formed using a synthetic resin material such as transparent acrylic or polycarbonate, for example. The support part 7 includes a conical portion 70 and a cylindrical portion 71. In addition, the support part 7 also includes a pointer 700 as a transmission portion that transmits a portion of the illumination light 30 that has been transmitted through the transmission opening 50 of the light-blocking part 5. Also, the support part 7 includes a function display 704 that transmits a portion of the illumination light 31 propagated in the cylindrical portion 71.

The side surface 702 of the conical portion 70 is painted black in order to block the illumination light 30. The pointer 700 for indicating the display target of the illumination target is formed in the vicinity of the outer periphery of the conical portion 70. The pointer 700 is an opening, for example, and is formed using a laser or the like.

In addition, the upper portion of the conical portion 70 is cut off to form the upper surface 701. The upper surface 701 is painted black in order to block the illumination light 31, and the function display 704 is formed as an opening by a laser or the like. As an example, the function display 704 is formed at a location where the upper surface 701 rises upward. The operation part 8 is supported by this location and serves as an axis, and rotates together with the display portion 6.

The function display 704 displays function names that can be set by the rotational operation device 1. This function display 704 is displayed on the operation part 8 as a result of the illumination light 31 being transmitted.

As described above, the cylindrical portion 71 is provided with a protrusion 710 on the lower side surface. The protrusion 710 is attached to the encoder 4.

As illustrated in FIG. 3B, as an example, the illumination light 30 is emitted from the side surface 80 of the operation part 8 via the bottom surface 65 of the display portion 6 and the pointer 700 of the conical portion 70. Via this emission, the pointer 700 is displayed on the side surface 80 of the operation part 8.

In addition, as illustrated in FIG. 3B as an example, the illumination light 31 is emitted from the upper surface 82 of the operation part 8 via the cylindrical portion 71 and the function display 704. Via this emission, the function display 704 is displayed on the upper surface 82 of the operation part 8.

### Configuration of Operation Part 8

As illustrated in FIG. 1, the operation part 8 has a shape like a cone with the upper portion cut off. An operator grips the side surface 80 of the operation part 8 and rotates it forward and backward to display a desired temperature. Note that, in FIG. 3B, the forward rotation is a clockwise rotation in which the numbers of the temperature display 601 become smaller. In addition, the backward rotation is a counterclockwise rotation in which the numbers of the temperature display 601 become larger.

An insertion recess 83 into which the conical portion 70 of the support part 7 is inserted is provided on the lower surface 81 of the operation part 8.

The operation part 8 is formed using a transparent synthetic resin material such as acrylic or polycarbonate, for example. As illustrated in FIG. 3A and FIG. 3B, the operation part 8 is subjected to a smoke treatment such that the temperature display 601 of the display portion 6, the pointer 700 of the support part 7, and the function display 704 cannot be visually recognized with natural light alone.

As an example of the operation part 8, the synthetic resin material is first cut out into the shape of the operation section 8, and the cut out portion is coated black and smoke treated. This operation part 8 is coated such that the light transmittance is less than or equal to 10%. Note that, as a modification, smoke may be formed in the operation part 8 by diffusing a substance that absorbs light, such as carbon black, into a synthetic resin material, for example.

In addition, the main body 10 of the rotational operation device 1 is formed of the same material as that of the operation part 8, and similarly coated in black. Accordingly, as illustrated in FIG. 3A, the temperature display 601 of the display portion 6, the pointer 700 of the support part 7, and the function display 704 of the rotational operation device 1 are not displayed with natural light alone when the light source 3 is not emitting light, and remain in a blackout state.

As illustrated in FIG. 3A and FIG. 3B, for example, a circular recessed portion 100 is formed in the main body 10 of the rotational operation device 1, and the operation part 8 protrudes from the circular recessed portion 100. The gap between the circular recessed portion 100 and the operation part 8 is small enough that it is inconspicuous when blacked out. Also, the front surface 101 of the main body 10 and the outer peripheral portion of the side surface 80 of the operation part 8 are smoothly connected.

### Configuration of Controller 9

The controller 9 is, for example, a microcomputer that includes a Central Processing Unit (CPU) that carries out computations, processes, and the like on acquired data in accordance with stored programs, Random Access Memory (RAM) and Read Only Memory (ROM) that are semiconductor memories, and the like. A program for operating the controller 9 is stored in the ROM, for example. The RAM is used as a storage region that temporarily stores computation results and the like, for example.

As illustrated in FIG. 3A, before an operator turns on the power of the vehicle, the main body 10 and the operation part 8 appear black with nothing displayed to the operator.

Then, when the power of the vehicle is turned on, for example, the controller 9 generates a drive signal S₁ and outputs it to the light source 3. Since the illumination light 30 is output from the operation part 8 via the transmission opening 50 of the light-blocking part 5, the temperature display 601 of the illumination target of the display portion 6, and the adjacent temperature display 601 when the light-emitting element 3a and the light-emitting element 3b of the light source 3 output the illumination light 30 and the illumination light 31 on the basis of the input drive signal S₁, the temperature display 601 appears to an operator as though it were displayed on the operation part 8 with a black background.

In addition, since the illumination light 30 is output from the operation part 8 via the transmission opening 50, the display portion 6 and the pointer 700, the pointer 700 appears to the operator as though it were displayed on the operation part 8 with a black background.

Furthermore, since the illumination light 31 is output from the operation part 8 via the cylindrical portion 71 and the function display 704, the function display 704 appears to the operator as though it were displayed on the operation part 8 with a black background.

Also, when the operation part 8 is rotated, the display portion 6 and the rotation portion 41 of the encoder 4 rotate together with the operation part 8, and the controller 9 detects the rotation of the rotation portion 41 via the detector 40. The encoder 4 generates the rotation amount information S₂ on the basis of the detected rotation amount, and outputs it to the controller 9. The controller 9 generates operation information S₃ on the basis of the obtained rotation amount information S₂, and outputs it to the air conditioning device. Note that, although the operation information S₃ may include information obtained by converting the rotation amount into the set temperature, for example, this embodiment is not limited thereto, and a configuration may also be used in which only information regarding the rotation amount is included, and the air conditioning device converts the rotation amount into the set temperature.

### Effects of Embodiment

The rotational operation device 1 according to the present embodiment can perform display similar to that of a digital display at a low cost using an analog mechanism. In particular, the rotational operation device 1 includes an analog mechanism which is opaque when the operation part 8 is not illuminated, and in which the temperature display 601, the pointer 700, and the function display 704 can be visually recognized when illuminated.

Accordingly, the rotational operation device 1 can perform display similar to that of a digital display at a low cost using an analog mechanism in comparison to cases where such a mechanism is not utilized.

Since the rotational operation device 1 can display a current set temperature in numerals even in a case where it is not equipped with a liquid crystal display, it can be manufactured at a low cost in comparison to cases where a liquid-crystal display is utilized.

Since the temperature display 601, the pointer 700, and the function display 704 are displayed on the operation part 8 of the rotational operation device 1, in comparison to cases where this information is displayed outside the rotating operation part, miniaturization can be achieved.

Since the rotational operation device 1 has a simple configuration, it is possible to easily change the display colors of the temperature display 601, the pointer 700, and the function display 704 by changing the colors of the illumination light 30 and the illumination light 31. In addition, by forming the temperature display 601, the pointer 700, and the function display 704 of the rotational operation device 1 with colored synthetic resin materials instead of as openings, it is possible to easily change the display colors.

Since the rotational operation device 1 displays the previous and next set temperatures of the current set temperature indicated by the pointer 700 as a gradation display 15, it is easier to understand the relationship between the operation direction of the operation part 8 and the set temperature to be set in comparison with cases where only the current set temperature is displayed. In addition, since the previous and next set temperatures are primarily displayed as a gradation in the rotational operation device 1, it is easier to understand the current set temperature in comparison with cases where the current set temperature and the next and previous set temperatures are illuminated in the same manner.

In the rotational operation device 1, the temperature display 601 and the like are displayed on the black background when the power source is turned on, and when the power supply is turned off, the display disappears and is blacked out, which is excellent from a design perspective.

In the rotational operation device 1, since the main body 10 and the operation part 8 are formed using a transparent synthetic resin material and the same black coating is applied, the main body 10 and the operation part 8 are seamless, and have an excellent design.

Although several embodiments and modifications of the invention have been described above, these embodiments and modifications are merely examples, and the invention according to the claims is not intended to be limited to the embodiments and modifications. Such novel embodiments and modifications can be implemented in various other forms, and various omissions, substitutions, changes, and the like can be made without departing from the spirit and scope of the present invention. In addition, all combinations of the features described in these embodiments and modifications are not necessary means to solve the problem. Furthermore, these embodiments and modifications are included within the spirit and scope of the invention and also within the scope of the invention described in the claims and equivalents thereof.

### REFERENCE SIGNS LIST

1 Rotational operation device
3 Light source
5 Light-blocking part
6 Display portion
7 Support part
8 Operation part
30, 31 Illumination light
40 Detector
41 Rotation portion
50 Transmission opening
601 Temperature display
700 Pointer
701 Upper surface
704 Function display

1. A rotational operation device, comprising:
a light source configured to output illumination light;
a display portion comprising a plurality of display targets formed in a circumferential direction, a transmission region that transmits the illumination light, and a light-blocking region that blocks the illumination light; and
an operation part configured to rotate together with the display portion in accordance with a performed rotation operation,
wherein the operation part is opaque and allows visual recognition of the plurality of display targets by the illumination light output from the light source and transmitted through the transmission region of the display portion.

2. The rotational operation device according claim 1, further comprising a light-blocking part disposed between the display portion and the light source to block the illumination light,
wherein the light-blocking part comprises a transmission opening through which the illumination light is transmitted, and
wherein the display portion is illuminated by the illumination light transmitted through the transmission opening.

3. The rotational operation device according to claim 2, further comprising a support part disposed between the display portion and the operation part to support a rotation of the operation part together with the display portion and to partially block the illumination light,
wherein the support part comprises a transmission unit that transmits a portion of the illumination light transmitted through the transmission opening of the light-blocking part.

4. The rotational operation device according to claim 3, wherein the support part further comprises another display target that is formed on an upper surface and is illuminated by the illumination light.

5. The rotational operation device according to claim 2, wherein the transmission opening of the light-blocking part has a shape that corresponds to one display target of the plurality of display targets that serves as an illumination target and display targets on both sides of the one display target, and
wherein the display targets on both sides are partially illuminated to be gradation-displayed.

6. The rotational operation device according to claim 1, further comprising a rotation detector configured to detect rotation of the operation part by detected rotation of the display portion.

7. The rotational operation device according to claim 1, wherein the transmission region of the display portion comprises a region in which the plurality of display targets are formed.

8. The rotational operation device according to claim 1, wherein the operation part comprises a transparent synthetic resin material, and
wherein the synthetic resin material is subjected to a treatment for lowering light transmittance or comprises a light absorbing substance.

9. The rotational operation device according to claim 1, wherein a light transmittance of the synthetic resin material is decreased to an extent such that the plurality of display targets are not visually recognized if the illumination light is not output.

10. The rotational operation device according to claim 9, wherein a light transmittance of the synthetic resin material is not more than 10%.
